(19) United States
(12) Patent Application Publication
(10) Pub. No.: US 2021/0065033 A1
(43) Pub. Date: Mar. 4, 2021

(54) SYNTHETIC DATA GENERATION USING BAYESIAN MODELS AND MACHINE LEARNING TECHNIQUES

(71) Applicant: Tata Consultancy Services Limited, Mumbai (IN)

(72) Inventors: Shruti KUNDE, Thane (IN); Mayank MISHRA, Thane (IN); Amey PANDIT, Thane (IN)

(73) Assignee: Tata Consultancy Services Limited, Mumbai (IN)

(21) Appl. No.: 16/997,839

(22) Filed: Aug. 19, 2020

(30) Foreign Application Priority Data
Aug. 21, 2019 (IN) 201921032785

(51) Int. Cl. G06N 7/00; G06N 20/00; G06F 17/18

(52) U.S. Cl. CPC G06N 7/005; G06F 17/18; G06N 20/00

(57) ABSTRACT

Synthetic data generation using conventional statistical approaches or Machine Learning based approaches are not effective as each of them used independently does not capture the features/advantages of the other approach. The method disclosed provides a hybrid approach. A Bayesian model is used for generating synthetic data based on a single behavioral user trait for a plurality of rows. Further, a Machine learning (ML) model based approach is used to incrementally generate the remaining columns of the data set providing values of other features of interest.

### CROSS-REFERENCE TO RELATED APPLICATIONS AND PRIORITY

The present application claims priority under 35 U.S.C. § 119 from India Application No. 201921032785, filed on Aug. 21, 2019.

### TECHNICAL FIELD

The disclosure herein generally relates to synthetic data generation, and more particularly to, hybrid approach for synthetic data generation using of Bayesian models and machine learning (ML) techniques.

### BACKGROUND

Synthetic data generation is an area of research and development considering usage of such data in various applications. In typical scenarios, synthetic data provides data that is not real, for cases where there may be limitation or restriction in use of real data. In another scenario, synthetic data is critical when large volumes of data is required for analysis while the data available is sensitive or extracting real data may be a challenge. Conventional methods of synthetic data generation rely solely on statistical techniques, while recent developments provide machine learning (ML) techniques for synthetic data generation. However, each of the statistical and ML based synthetic data generation has limitation. Bayesian networks for data generation become complex for a large number of columns in the dataset. The ML based techniques do not capture the statistical aspects in the data.

### SUMMARY

Embodiments of the present disclosure present technological improvements as solutions to one or more of the above-mentioned technical problems recognized by the inventors in conventional systems. For example, in one embodiment, a method for synthetic data generation using Bayesian model and machine learning (ML) techniques is provided. The method comprises computing a plurality of prior probabilities, associated with occurrence of an event for a user behavioral trait of a plurality of users, from a data set. Further, the method comprises obtaining a prior probability distribution of the plurality of users based on the computed plurality of prior probabilities. Further, the method comprises computing a plurality of posterior probabilities from the prior probability distribution using a Bayesian model. Further, the method comprises obtaining a posterior probability distribution based on the computed plurality of posterior probabilities using the Bayesian model. Further, the method comprises obtaining distribution parameters from the posterior probability distribution. Further, the method comprises determining percentage of occurrence of the event from the data set, for each user among the plurality of users. Furthermore, the method comprises applying an oversampling technique over the data set to generate a plurality of rows comprising a first set of synthetic data for the user behavioral trait in accordance with the distribution parameters and the percentage of occurrence of the event. Further, the method comprises updating the dataset with the plurality of rows of the first set of synthetic data. Furthermore, the method comprises providing the updated data set to a machine learning (ML) model for generating a second set of synthetic data corresponding to a plurality of features for each row of the updated data set based on an iterative process, wherein the iterative process terminates when the second set of synthetic data is generated for a plurality of features.

In another aspect, a system for synthetic data generation using Bayesian model and machine learning (ML) techniques is provided. The system comprises a memory storing instructions; one or more Input/Output (I/O) interfaces; and processor(s) coupled to the memory via the one or more I/O interfaces, wherein the processor(s) is configured by the instructions to computing a plurality of prior probabilities, associated with occurrence of an event for a user behavioral trait of a plurality of users, from a data set. Further, the processor(s) is configured to obtain a prior probability distribution of the plurality of users based on the computed plurality of prior probabilities. Further, the processor(s) is configured to compute a plurality of posterior probabilities from the prior probability distribution using a Bayesian model. Further, the processor(s) is configured to obtain a posterior probability distribution based on the computed plurality of posterior probabilities using the Bayesian model. Further, the processor(s) is configured to obtain distribution parameters from the posterior probability distribution. Further, the processor(s) is configured to determine percentage of occurrence of the event from the data set, for each user among the plurality of users. Furthermore, the processor(s) is configured to apply an oversampling technique over the data set to generate a plurality of rows comprising a first set of synthetic data for the user behavioral trait in accordance with the distribution parameters and the percentage of occurrence of the event. Further, the processor(s) is configured to update the dataset with the plurality of rows of the first set of synthetic data. Furthermore, the processor(s) is configured to provide the updated data set to a machine learning (ML) model for generating a second set of synthetic data corresponding to a plurality of features for each row of the updated data set based on an iterative process, wherein the iterative process terminates when the second set of synthetic data is generated for a plurality of features.

In yet another aspect, there are provided one or more non-transitory machine readable information storage mediums comprising one or more instructions, which when executed by one or more hardware processors causes a method for computing a plurality of prior probabilities, associated with occurrence of an event for a user behavioral trait of a plurality of users, from a data set. Further, the method comprises obtaining a prior probability distribution of the plurality of users based on the computed plurality of prior probabilities. Further, the method comprises computing a plurality of posterior probabilities from the prior probability distribution using a Bayesian model. Further, the method comprises obtaining a posterior probability distribution based on the computed plurality of posterior probabilities using the Bayesian model. Further, the method comprises obtaining distribution parameters from the posterior probability distribution. Further, the method comprises determining percentage of occurrence of the event from the data set, for each user among the plurality of users. Furthermore, the method comprises applying an oversampling technique over the data set to generate a plurality of rows comprising a first set of synthetic data for the user behavioral trait in accordance with the distribution parameters and the percentage of occurrence of the event. Further, the method comprises updating the dataset with the plurality of rows of the first set of synthetic data. Furthermore, the method comprises providing the updated data set to a machine learning (ML) model for generating a second set of synthetic data corresponding to a plurality of features for each row of the updated data set based on an iterative process, wherein the iterative process terminates when the second set of synthetic data is generated for a plurality of features.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of a system for synthetic data generation using Bayesian models and Machine Learning (ML) techniques, in accordance with some embodiments of the present disclosure.

FIG. 2 is a flow diagram illustrating a method for synthetic data generation using Bayesian models and Machine Learning (ML) techniques using system of FIG. 1, in accordance with some embodiments of the present disclosure.

FIG. 3A through 3E illustrates the method of FIG. 2 based on a use case example, in accordance with some embodiments of the present disclosure.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims.

The embodiments herein provide a method and system for synthetic data generation using Bayesian models and Machine Learning (ML) techniques. The method disclosed provides a hybrid approach. A Bayesian model is used for generating synthetic data based on a single behavioral user trait. Further, a Machine learning (ML) model based approach is used to incrementally generate the remaining features of the data set. Since machine learning based models are capable of automatically learning/identifying patterns in the data, the method reduces manual intervention to minimal, which otherwise is necessary for solely statistical approaches. Such intervention may be necessary in statistical approaches for finding maximum cliques in Markov models, identifying the distributions and the like. However, the present disclosure uses Bayesian model only for generating data for a specific user behavioral trait—unlike the existing works in the literature, which use Bayesian for generation of the entire synthetic data set. Relying only on Bayesian network for generating a large number of columns in the dataset has is not very practical as the data generation becomes complex with Bayesian network when generating for a large number of columns or multiple features of the dataset. However, Bayesian network is very good in generating time series data like interarrival timestamps, event occurrences, which is not captured by a ML models used for data generation. Thus, the method disclosed provides a combinational or hybrid approach, to capture advantages of Bayesian and ML approaches.

Once a subset of the synthetic data is generated by Bayesian models, an incremental approach based on machine learning techniques is implemented and executed by the system of the present disclosure to predict the data of the remaining columns of the data set.

In the method disclosed, the Bayesian model enables to identify a set of columns based on the use case defined and generate data with minimal information. Further, the ML model needs an initial data for bootstrapping, which is provided by data generated by the Bayesian model.

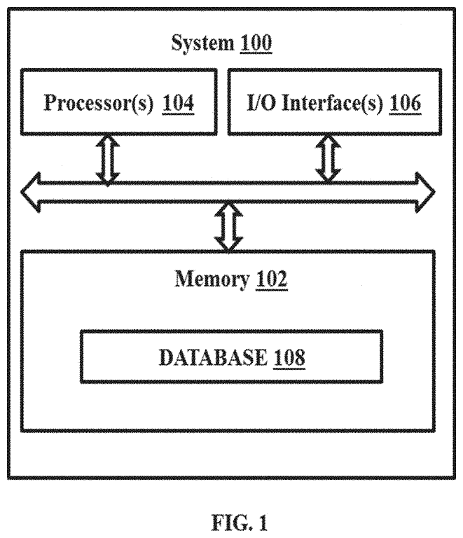

Referring now to the drawings, and more particularly to FIGS. 1 through 3E, where similar reference characters denote corresponding features consistently throughout the figures, there are shown preferred embodiments and these embodiments are described in the context of the following exemplary system and/or method.

FIG. 1 is a functional block diagram of a system for synthetic data generation using Bayesian models and Machine Learning (ML) techniques, in accordance with some embodiments of the present disclosure.

In an embodiment, the system 100 includes a processor(s) 104, communication interface device(s), alternatively referred as or input/output (I/O) interface(s) 106, and one or more data storage devices or memory 102 operatively coupled to the processor(s) 104. The processors(s) 104, can be one or more hardware processors. In an embodiment, the one or more hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud and the like.

The I/O interface(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment the memory 102, includes a Bayesian model (not shown) and a ML model (not shown). The memory 102, may further store a data set that may be received from external sources via the I/O interface(s) 106. Further, the memory 102 may store prior probabilities, prior distributions, posterior probabilities, posterior distribution, generated synthetic data, and updated data set in a database 108. Thus, the memory 102 may comprise information pertaining to input(s)/output(s) of each step performed by the processor(s) 104 of the system 100 and methods of the present disclosure.

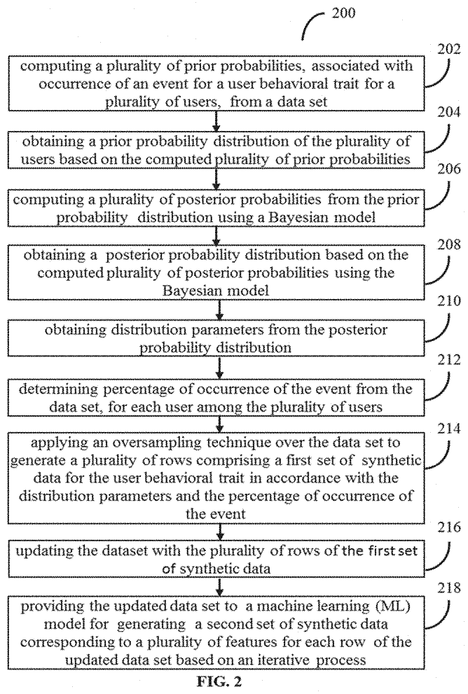

FIG. 2 is a flow diagram illustrating a method 200 for synthetic data generation using the Bayesian models and the Machine Learning (ML) techniques using the system 100 of FIG. 1, in accordance with some embodiments of the present disclosure.

In an embodiment, the system 100 comprises one or more data storage devices or the memory 102 operatively coupled to the processor(s) 104 and is configured to store instructions for execution of steps of the method 200 by the processor (s) 104. The steps of the method 200 of the present disclosure will now be explained with reference to the components or blocks of the system 100 as depicted in FIG. 1 and the steps of flow diagram as depicted in FIG. 2. Although process steps, method steps, techniques or the like may be described in a sequential order, such processes, methods and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring to the steps of the method 200, in an embodiment of the present disclosure, at step 202, the processor (s) 104 compute a plurality of prior probabilities from a data set. The prior probabilities are associated with occurrence of an event for a user behavioral trait of a plurality of users. An example data set is depicted in table 1 and information gathered from the data set is depicted in table 2 below.

TABLE 1

| | | | |
|---|---|---|---|
| # time stamp | | | |
| The time since event | | | |
| has occurred since year | # visitor id | | |
| 1970 in milliseconds | or user id | | # item id |
| (Standard UNIX time tamp) | (unique) | event | (unique) |

| | | | |
|---|---|---|---|
| 13 | 143322422949X | 15795 | view |
| 14 | 143322369735X | 598426 | view |
| 15 | 143322xxx . . . | 623.XXX | view |
| 16 | 143322yyy . . . | 156XXX | view |
| 17 | 143322zzz . . . | 467XXXX | view |
| 18 | 143322 . . . | . . . | add to |
| | | | cart |
| 19 | 143322 . . . | . . . | view |
| 20 | 143322 . . . | . . . | add to |
| | | | cart |
| 21 | 143322 . . . | . . . | view |
| 22 | 143322 . . . | . . . | view |
| 23 | 143322 . . . | . . . | view |
| 24 | 143322 . . . | . . . | view |
| 25 | 143322 . . . | . . . | view |
| 26 | 143322 | . . . | |

TABLE 2

| | | |
|---|---|---|
| # visitor id | Views (V) before | |
| or user id | Add to cart (ATC) | Views before order |

| (unique) | V < 10 | V >= 10 | V < 10 | V >= 10 |
|---|---|---|---|---|
| 15795 | 196 | 46 | 134 | 36 |
| 598426 | 125 | 16 | 73 | 26 |
| 623.XXX | 98 | 19 | 76 | 15 |
| 156XXX | 112 | 10 | 111 | 8 |
| 467XXXX | 50 | 20 | 45 | 15 |

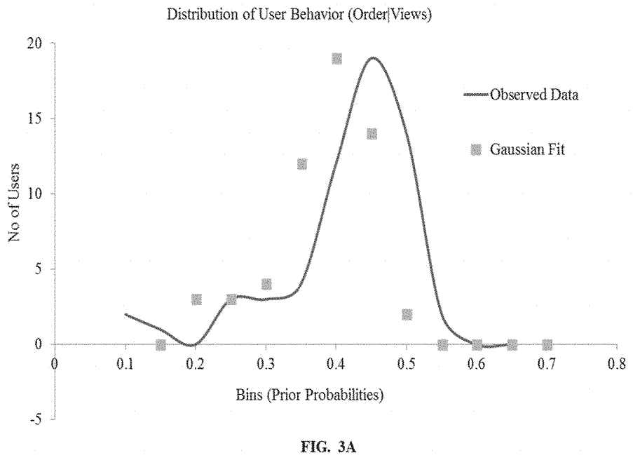

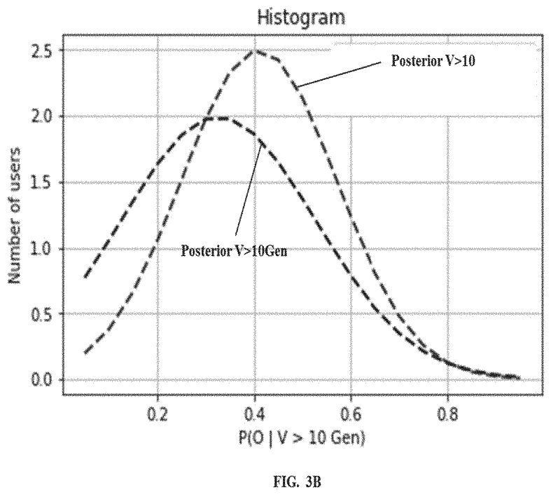

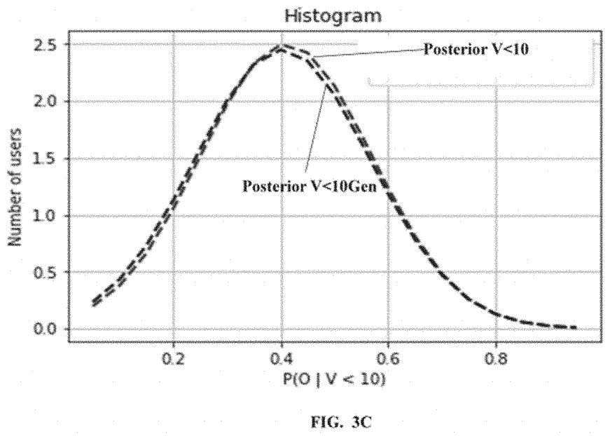

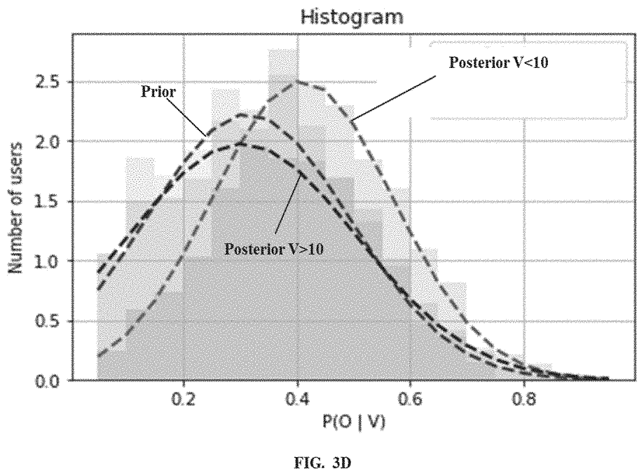

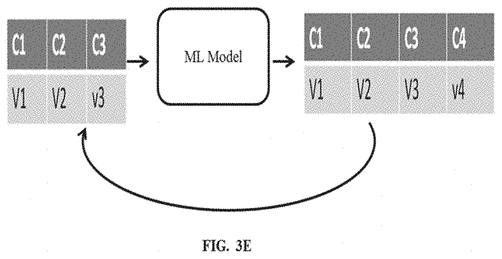

The example dataset of table 1 provides records for an online shopping website indicating time stamp, unique user/visitor id, and actions of corresponding user (‘viewing a product’ or ‘adding the product to cart after viewing’), wherein product is identified with a unique item id. The table 2 depicts statistical information derived from the data set, indicating a user behavioral trait observed for placement or no placement of order for a product, post certain number of views of the product on the website. Thus, from the statistical analysis, the plurality of prior probabilities, associated with occurrence of the event for the user behavioral trait are computed. This is depicted in example probability distribution of FIG. 3A. For example, the event may be placement of order post N views of the product.

Referring to the steps of the method 200, at step 204, the processor(s) 104 is configured to obtain a prior probability distribution of the plurality of users based on the computed plurality of prior probabilities. An example probability distribution is depicted in FIG. 3B and FIG. 3C for views greater than 10 and views less than 10 respectively.

Referring to the steps of the method 200, at step 206, the processor(s) 104 compute a plurality of posterior probabilities from the prior probability distribution using a Bayesian model. Referring to the steps of the method 200, at step 208, the processor(s) 104 obtain a posterior probability distribution based on the computed plurality of posterior probabilities using the Bayesian model. The Bayesian model as known in the art, provides output posterior probability distribution as depicted in FIG. 3D, indicating number of users against posterior probability of those users placing an order for the product before viewing 10 times or post 10 minimum views. As understood, in statistical Bayesian analysis, the posterior distribution is a way to summarize what we know about uncertain quantities. It is a combination of the prior distribution and a likelihood function.

Mathematical/Statistical representation of the steps 202 through the 208 is provided below.

Assume fₚ(cᵢ) is the prior probability computed from statistical analysis of the dataset, which is provided to the Bayesian model. The Bayesian model, providing posterior probability (output—fₚₚ(cᵢ|cⱼ)) is represented by equation below.

$${f}_{pp} ( {c}_{i} \vert {c}_{j} ) = \frac{{f}_{p} ( {c}_{i} ) . {f}_{c} ( {c}_{j} \vert {c}_{i} )}{\int {f}_{p} ( {c}_{i} ) . {f}_{c} ( {c}_{j} \vert {c}_{i} ) dx} \qquad ( 1 )$$

The details of the Bayesian model used are provided below:

Prior Probabilities based on observed data are Pₚᵣ x=xᵢ (2)

Conditional Probability for a use case (user behavioral trait under consideration:

P_{c}(y=yⱼ|x=xᵢ) (3)

Thus, a Joint Probability is given by:

$$\begin{matrix} {P}_{j} ( x = {x}_{i} \vert y = {y}_{j} ) = {P}_{pr} x = {x}_{i} * {P}_{c} ( y = {y}_{j} \vert x = {x}_{i} ) & ( 4 ) \\ Marginal Probability {P}_{m} ( y = {y}_{j} ) = Σ {P}_{j} ( x = {x}_{i} \vert y = {y}_{j} ) & ( 5 ) \\ Posterior Probability {P}_{p} ( x = {x}_{i} \vert y = {y}_{j} ) = \frac{{P}_{j} ( x = {x}_{i} \vert y = {y}_{j} )}{{P}_{m} ( y = {y}_{j} )} & ( 6 )\end{matrix}$$

The posterior probability distribution further revises the probability of the event under the specific behavioral trait for which data is recorded in the data set. However, posterior probability distribution does not help in adding to number of observations recorded in the data set. The, method 200 enables multifold generation of synthetic data corresponding to the rows of observation data for the event for the user behavior trait under consideration. For example, for observed 100 rows the method can generate 1000 rows of synthetic data. The steps 210 through 216, explained below describe the generation of rows of synthetic data:

Referring to the steps of the method 200, at step 210, the processor(s) 104 obtain distribution parameters from the posterior probability distribution. As can be understood by person skilled in the art, every distribution has parameters specific to the distribution. These are regular statistical distributions with standard parameters. Thus, the posterior distribution could follow any statistical distribution.

Referring to the steps of the method 200, in an embodiment of the present disclosure, at step 212, the processor(s) 104, determine percentage of occurrence of the event from the data set, for each user among the plurality of users.

Referring to the steps of the method 200, in an embodiment of the present disclosure, at step 214, the processor(s) 104, apply an oversampling technique over the data set to generate a plurality of rows of a first set of synthetic data (refers to synthetic data corresponding to rows) for the user behavioral trait in accordance with the distribution parameters and the percentage of occurrence of the event. Known oversampling mechanisms such as Random oversampling, SMOTE can be used.

Referring to the steps of the method 200, at step 216, the processor(s) 104, is configured to update the dataset with the plurality of rows of the first set of synthetic data. Thus, the table 1 above is updated with more number of rows with the generated synthetic data. Sample table 3 below provides statistical analysis on the updated table 1, which includes the generated synthetic data.

TABLE 3

| | Prior | | Posterior (V > x) | | Posterior (V < x) | |
|---|---|---|---|---|---|---|
| | | Gaussian | | Gaussian | | Gaussian |
| | Data | fit | Data | fit | Data | fit |
| Mean | 0.31 | 0.30 | 0.30 | 0.32 | 0.41 | 0.40 |
| Median | 0.39 | 0.29 | 0.36 | 0.34 | 0.41 | 0.38 |
| Kurtosis | 0.764 | 0.03 | 0.42 | 0.92 | 4.96 | −0.73 |
| Skewness | 0.915 | −0.05 | 0.05 | −0.49 | 0.42 | 0.18 |

However, the generated synthetic data provides data related to only the prior considered user behavioral trait. The method 200 is able to generate addition synthetic data for a plurality of features of interest associated with the event, which were not recorded in recordings captured from real actions. Thus, the ML model captures the associativity across the columns (for a row) in a dataset. However, if only the Bayesian model is used for the additional features, the Bayesian model samples these columns corresponding to the features independently, effectively resulting in loss of relationships across the columns. For example, the features of interest associated with the user behavioral trait associated with the event could be age of the users, income band of the user, geographical locations of the user and the like. Data generated synthetically for such features, which was not available from the actual data recordings enables better and accurate future predictions required from the data analytics.

Referring to the steps of the method 200, in an embodiment of the present disclosure, at step 218, the processor(s) 104, provides the updated data set to the machine learning (ML) model for generating a second set of synthetic data corresponding to the plurality of features for each row of the updated data set based on an iterative process. Any standard ML models can be used, by identifying a ML model that best fits the data set under consideration. For example, Standard ML models used include Xgboost, SVM, LSTM or the like.

The sub steps of the step 218 are explained in conjunction with FIG. 3E. Initially, a feature (say C1) is selected from the plurality of features (C1, C2, C3, C4) for which synthetic data is to be generated. At first, using the updated data set, the ML model predicts synthetic data (value V1 of feature C1) corresponding to the feature for each row of the updated dataset. This updated data set and the predicted synthetic data is provided back as input to the ML model to predict synthetic data for a next feature selected (C2) from the plurality of features. Further, this process repeats or iterates to predict synthetic data using the ML model for all remaining features, selected in sequence.

Table 4 below is a sample illustrative table depicting a final data set with multiple rows (first set of synthetic data) and columns added (second set of synthetic data), in bold font, generated by the method 200.

TABLE 4

| | | # visitor id | | C1 | C2 | C3 |
|---|---|---|---|---|---|---|
| | | or user id | | (Geog- | (user | (income |
| | # time stamp | (unique) | event | location | age) | slab) |
| 13 | 143322422 . . . | 15795 | view | V1 | V2 | V3 |
| 13a | 143322369 . . . | 598426 | view | V1 | V2 | V3 |
| 13b | 143322nn . . . | 623.XXX | view | | | |
| 13c | 143322pp . . . | 156XXX | view | | | |
| . . . | . . . | . . . | . . . | . . . | | |
| . . . | . . . | | . . . | . . . | | |
| 14 | 143322zzz . . . | 467XXXX | view | | | |
| 14a | 143322 . . . | . . . | add to | | | |
| | | | cart | | | |
| 14b | 143322 . . . | . . . | view | | | |
| 20 | 143322 . . . | . . . | add to | | | |
| | | | cart | | | |
| 21 | 143322 . . . | . . . | view | | | |
| 22 | 143322 . . . | . . . | view | | | |
| 23 | 143322 . . . | . . . | view | | | |
| 24 | 143322 . . . | . . . | view | | | |
| 25 | 143322 . . . | . . . | view | | | |
| 26 | 143322 | . . . | | | | |
| . . . | . . . | . . . | | | | |
| . . . | . . . | . . . | | | | |
| Row | | | | | | |
| 1000 | | | | | | |

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, the method comprising:
computing, via one or more hardware processors, a plurality of prior probabilities, associated with occurrence of an event for a user behavioral trait of a plurality of users, from a data set;
obtaining, via the one or more hardware processors, a prior probability distribution of the plurality of users based on the computed plurality of prior probabilities;
computing, via the one or more hardware processors, a plurality of posterior probabilities from the prior probability distribution using a Bayesian model;
obtaining, via the one or more hardware processors, a posterior probability distribution based on the computed plurality of posterior probabilities using the Bayesian model;
obtaining, via the one or more hardware processors, distribution parameters from the posterior probability distribution;
determining, via the one or more hardware processors, a percentage of occurrence of the event from the data set, for each user among the plurality of users;
applying, via the one or more hardware processors, an oversampling technique over the data set to generate a plurality of rows comprising a first set of synthetic data for the user behavioral trait in accordance with the distribution parameters and the percentage of occurrence of the event;
updating, via the one or more hardware processors, the data set with the plurality of rows of the first set of synthetic data; and
providing, via the one or more hardware processors, the updated data set to a machine learning (ML) model for generating a second set of synthetic data corresponding to a plurality of features for each row of the updated data set based on an iterative process, wherein the iterative process terminates when the second set of synthetic data is generated for a plurality of features.

2. The method of claim 1, wherein the step of generating a second set of synthetic data corresponding to the plurality of features for each row of the updated data set using the ML model based on the iterative process comprises:
selecting a feature among the plurality of features, for which synthetic data is to be generated;
predicting synthetic data corresponding to the feature for each row of the updated data set;
providing the updated data set and the predicted synthetic data for the feature to predict synthetic data for a next feature selected from the plurality of features; and
repeating process of predicting synthetic data using the ML model until a last feature is selected sequentially from the plurality of features.

3. A system, comprising:
a memory storing instructions;
one or more Input/Output (I/O) interfaces; and
one or more processor(s) coupled to the memory via the one or more I/O interfaces, wherein the one or more processor (s) are configured by the instructions to:
compute a plurality of prior probabilities, associated with occurrence of an event for a user behavioral trait of a plurality of users, from a data set;
obtain a prior probability distribution of the plurality of users based on the computed plurality of prior probabilities;
compute a plurality of posterior probabilities from the prior probability distribution using a Bayesian model;
obtain a posterior probability distribution based on the computed plurality of posterior probabilities using the Bayesian model;
obtain distribution parameters from the posterior probability distribution;
determine percentage of occurrence of the event from the data set, for each user among the plurality of users;
apply an oversampling technique over the data set to generate a plurality of rows comprising a first set of synthetic data for the user behavioral trait in accordance with the distribution parameters and the percentage of occurrence of the event;
update the dataset with the plurality of rows of the first set of synthetic data; and
provide the updated data set to a machine learning (ML) model for generating a second set of synthetic data corresponding to a plurality of features for each row of the updated data set based on an iterative process, wherein the iterative process terminates when the second set of synthetic data is generated for a plurality of features.

4. The system of claim 3, wherein the processor(s) is further configured to generate the second set of synthetic data corresponding to the plurality of features for each row of the updated data set using the ML model, based on the iterative process, by:
selecting a feature among the plurality of features, for which synthetic data is to be generated;
predicting synthetic data corresponding to the feature for each row of the updated dataset;
providing the updated data set and the predicted synthetic data for the feature to predict synthetic data for a next feature selected from the plurality of features; and
repeating process of predicting synthetic data using the ML model until a last feature is selected sequentially from the plurality of features.

5. One or more non-transitory machine readable information storage mediums comprising one or more instructions which when executed by one or more hardware processors causes a method for:
computing a plurality of prior probabilities, associated with occurrence of an event for a user behavioral trait of a plurality of users, from a data set;
obtaining a prior probability distribution of the plurality of users based on the computed plurality of prior probabilities;
computing a plurality of posterior probabilities from the prior probability distribution using a Bayesian model;
obtaining a posterior probability distribution based on the computed plurality of posterior probabilities using the Bayesian model;
obtaining distribution parameters from the posterior probability distribution;
determining a percentage of occurrence of the event from the data set, for each user among the plurality of users;
applying an oversampling technique over the data set to generate a plurality of rows comprising a first set of synthetic data for the user behavioral trait in accordance with the distribution parameters and the percentage of occurrence of the event;
updating the data set with the plurality of rows of the first set of synthetic data; and
providing the updated data set to a machine learning (ML) model for generating a second set of synthetic data corresponding to a plurality of features for each row of the updated data set based on an iterative process, wherein the iterative process terminates when the second set of synthetic data is generated for a plurality of features.

6. The one or more transitory machine readable information storage mediums of claim 5, wherein the step of generating a second set of synthetic data corresponding to the plurality of features for each row of the updated data set using the ML model based on the iterative process comprises:
selecting a feature among the plurality of features, for which synthetic data is to be generated;
predicting synthetic data corresponding to the feature for each row of the updated data set;
providing the updated data set and the predicted synthetic data for the feature to predict synthetic data for a next feature selected from the plurality of features; and
repeating process of predicting synthetic data using the ML model until a last feature is selected sequentially from the plurality of features.
